(19) United States
(12) Patent Application Publication
(10) Pub. No.: US 2026/0048379 A1
(43) Pub. Date: Feb. 19, 2026

(54) NICKEL-MAGNESIUM LOADED BIOCHAR-BASED BIFUNCTIONAL MATERIAL AND PREPARATION METHOD THEREOF

(71) Applicant: ZHEJIANG UNIVERSITY, Hangzhou (CN)

(72) Inventors: Minghui TANG, Hangzhou (CN); Hongxian LI, Hangzhou (CN); Shengyong LU, Hangzhou (CN); Qi LIU, Hangzhou (CN); Ling WANG, Hangzhou (CN); Jianhua YAN, Hangzhou (CN)

(73) Assignee: ZHEJIANG UNIVERSITY, Hangzhou (CN)

(21) Appl. No.: 19/290,266

(22) Filed: Aug. 4, 2025

(30) Foreign Application Priority Data
Aug. 19, 2024 (CN) 202411137197.3

(51) Int. Cl. B01J 20/20

(52) U.S. Cl. CPC B01J 20/20; B01J 2220/42; B01J 2220/4806; B01J 2220/4875

(57) ABSTRACT

A method for preparing nickel-magnesium loaded biochar-based bifunctional material is provided. The method includes: carbonizing a waste biomass material and washing it in a sulfuric acid solution, followed by deionized water washing, suction filtration, and drying to obtain a carbonized biochar; adding Ni(NO₃)₂·6H₂O and Mg(NO₃)₂·6H₂O to deionized water and stirring uniformly to obtain a loading solution; weighing the carbonized biochar according to a nickel loading amount of 20%-50% and adding to the loading solution and stirring to obtain a mixed solution, transferring the mixed solution to an oil bath for drying until water is completely evaporated; transferring a solid material to a crucible and roasting in the muffle furnace at 550° C.-650° C. under the nitrogen atmosphere for 1.5 h-2.5 h to obtain the nickel-magnesium loaded biochar-based bifunctional material.

### CROSS REFERENCE TO RELATED APPLICATIONS

This application claims priority to the Chinese Patent Application No. 202411137197.3, filed on Aug. 19, 2024, the contents of which are hereby incorporated by reference.

### TECHNICAL FIELD

The present disclosure generally relates to the technical field of integrated carbon capture and utilization (ICCU), and in particular, to a nickel-magnesium loaded biochar-based bifunctional material and a preparation method thereof.

### BACKGROUND

The continuous emission of carbon dioxide is a major factor contributing to global climate warming. At present, carbon capture, utilization, and storage are key technical means and underlying technology guarantee for carbon emission reduction. Carbon capture, utilization, and storage are mainly composed of carbon dioxide capture, transportation, utilization, and storage, which is mainly divided into two categories: carbon capture and utilization (CCU) and carbon capture and storage (CCS). The former can realize the resource utilization of carbon dioxide, and convert the captured carbon dioxide into fuel or high-value chemicals to realize recycling of carbon dioxide; while the latter can bury the captured unavailable carbon dioxide through storage technology such as geological storage and oceanic storage. Although CCU can effectively alleviate excessive carbon emissions, it also suffers from high cost and high risk. For example, in the majority of current carbon capture and utilization, carbon capture and utilization are carried out separately, which requires a transportation process to connect the two, but the transportation process not only requires a large amount of manpower and resources, but also has the risk of leakage. CCS, as a supplement to CCU, can effectively handle captured unavailable carbon dioxide. However, storage does not convert carbon dioxide, instead, it is stored in a specific place, so there is a risk of potential leakage. Once the leakage occurs, it leads to large emission of carbon dioxide in a short time, causing catastrophic consequences.

Integrated carbon capture and utilization (ICCU) achieves rational coupling between the carbon capture stage and utilization stage, thereby providing comprehensive solutions to multiple inherent challenges associated with carbon capture, utilization and storage (CCUS). ICCU can directly enables capture, in-situ conversion, and utilization of carbon dioxide, without the transportation process, thereby avoiding associated costs and pipeline leakage risks, demonstrating good application prospects. Currently, ICCU research streams predominantly focus on Integrated Carbon Capture and Methanation (ICCM), Integrated Carbon Capture and Utilization with In-Situ Reverse Water-Gas Shift (IICCU-RWGS), and Integrated Carbon Capture and In-Situ Dry Methane Reforming (ICC-DR), among which, ICCM has a lower reaction temperature compared to the other two, demonstrating greater economic viability. The cornerstone of ICCM lies in dual functional materials (DFMs, also known as bifunctional materials), which incorporates both adsorption sites and catalytic sites. Recent studies have synthesized a series of Ni/MgO DFMs via mechanochemical method at room temperature for ICCM. The optimal 80 wt % Ni/MgO DFM demonstrated a carbon dioxide capture capacity of 0.37 mmol/g and a methane production amount of 0.27 mmol/g at 300° C., with a carbon dioxide conversion rate of 73% and a methane selectivity of 100%. However, the methanation performance of the pure metal oxide DFM remains low and requires further enhancement.

Currently, most DFMs composed of pure metals/metal oxides exhibit low ICCM performance, constraining further technological advancement. Consequently, the development of DFMs with excellent ICCM performance is of great significance for achieving China's “dual carbon” goals.

### SUMMARY

One or more embodiments of the present disclosure provide a method for preparing a nickel-magnesium loaded biochar-based bifunctional material. The method includes carbonizing a waste biomass material at 1000° C.-1200° C. under a nitrogen atmosphere, after cooling to a room temperature, washing a carbonized material in a sulfuric acid solution, followed by deionized water washing, suction filtration, and drying to obtain a carbonized biochar; adding Ni(NO₃)₂·6H₂O and Mg(NO₃)₂·6H₂O to deionized water and stirring uniformly to obtain a loading solution; weighing the roasted carbonized biochar according to a nickel loading amount of 20%-50% and adding to the loading solution and stirring to obtain a mixed solution, and transferring the mixed solution to an oil bath for stirring and drying until water is completely evaporated; and transferring a solid material to a crucible and roasting in the muffle furnace at 550° C.-650° C. under the nitrogen atmosphere for 1.5 h-2.5 h to obtain the nickel-magnesium loaded biochar-based bifunctional material.

In some embodiments, a nickel loading amount of the nickel-magnesium loaded biochar-based bifunctional material is 40%.

In some embodiments, the carbonized biochar is roasted in a muffle furnace at 550° C.-650° C. under the nitrogen atmosphere for 1.5 h-2.5 h.

In some embodiments, a concentration of the sulfuric acid solution is within a range of 0.4-0.5 mol/L, and a time of the washing is within a range of 10 h-12 h.

In some embodiments, during the preparation of the carbonized biochar, the nitrogen atmosphere is maintained at a flow rate of 100 mL/min, a heating rate is within a range of 8° C./min-10° C./min, and a holding time is within a range of 0.8 h-1.2 h.

In some embodiments, during the roasting of the solid material, the nitrogen atmosphere is maintained at a flow rate of 100 mL/min, and a heating rate is within a range of 4° C./min-5° C./min.

In some embodiments, the waste biomass material is one or a mixture of a corncob powder, a yellow bamboo powder, a wheat straw powder, and a corn stover powder.

One or more embodiments of the present disclosure provide a nickel-magnesium loaded biochar-based bifunctional material, which is prepared based on the method for preparing the nickel-magnesium loaded biochar-based bifunctional material as described hereinbefore.

One or more embodiments of the present disclosure provide a use of the nickel-magnesium loaded biochar-based bifunctional material in integrated flue gas carbon capture and in-situ methanation.

In some embodiments, a temperature for achieving the use is within a range of 300° C.-500° C.

In some embodiments, the temperature for achieving the use is 400° C.

### BRIEF DESCRIPTION OF THE DRAWINGS

The present disclosure will be further illustrated by way of exemplary embodiments, which will be described in detail by means of the accompanying drawings. These embodiments are not limiting, and in these embodiments, the same numbering denotes the same structure, wherein:

FIG. 1 is an exemplary flowchart illustrating an exemplary process of a method for preparing a nickel-magnesium loaded biochar-based bifunctional material according to some embodiments of the present disclosure;

FIG. 2 is a scanning electron microscope (SEM) image of 20% Ni@MgO—C prepared according to Example 1 of the present disclosure;

FIG. 3 is an SEM image of 40% Ni@MgO—C prepared according to Example 3 of the present disclosure;

FIG. 4 is a Transmission Electron Microscope (TEM) image of 40% Ni@MgO prepared according to Comparative Example 1 of the present disclosure;

FIG. 5 is an Energy Dispersive X-ray Spectroscopy (EDX) mapping image of 40% Ni@MgO—C prepared according Example 3 of the present disclosure;

FIG. 6 is an X-Ray Diffraction (XRD) pattern of the nickel-magnesium loaded biochar-based bifunctional materials prepared according to Examples 1 and 3, and Comparative Example 1 of the present disclosure;

FIG. 7 is a graph illustrating pore size distribution characteristics of the nickel-magnesium loaded biochar-based bifunctional materials prepared according to Example 3 and Comparative Example 1 of the present disclosure;

FIG. 8 is a graph illustrating pore structure parameters of the nickel-magnesium loaded biochar-based bifunctional materials prepared according to Example 3 and Comparative Example 1 of the present disclosure;

FIG. 9 is a graph illustrating H₂-hydrogen temperature-programmed reduction (TPR) results of the nickel-magnesium loaded biochar-based bifunctional materials prepared according to Example 3 and Comparative Example 1 of the present disclosure;

FIG. 10 is a comparison graph of CO₂ capture and methanation performance of the nickel-magnesium loaded biochar-based bifunctional materials prepared according to Examples 1-4 of the present disclosure;

FIG. 11 is a comparison graph of CO₂ capture and methanation performance of 40% Ni@MgO—C prepared according to Example 3 of the present disclosure at different reaction temperatures;

FIG. 12 is a comparison graph of CO₂ capture and methanation performance of 40% Ni@MgO prepared according to Comparative Example 1 of the present disclosure at different reaction temperatures; and

FIG. 13 is a graph illustrating cycling performance of 40% Ni@MgO—C prepared according to Example 3 of the present disclosure.

### DETAILED DESCRIPTION

The following embodiments are used herein to exemplify the technical solutions of the present disclosure. Those skilled in the art will appreciate that the techniques disclosed in the following embodiments represent techniques discovered by the inventor that can be used to implement the present disclosure, and thus can be considered as preferred embodiments for implementing the present disclosure. But those skilled in the art should understand according to the present disclosure that the particular embodiments disclosed herein can be modified in many ways and still obtain the same or similar results without departing from the spirit or scope of the present disclosure.

Unless otherwise defined, all technical and scientific terms used herein have the same meaning as commonly understood by those skilled in the art to which the present disclosure belongs, and the materials disclosed herein and cited therein are incorporated by reference. Those skilled in the art will realize, or will be able to understand by routine experimentation, many of the technical equivalents of many of the particular embodiments of the disclosure described herein. Such equivalents shall fall within the scope of the claims.

The technical solutions of the present disclosure are described in further detail below with reference to specific embodiments.

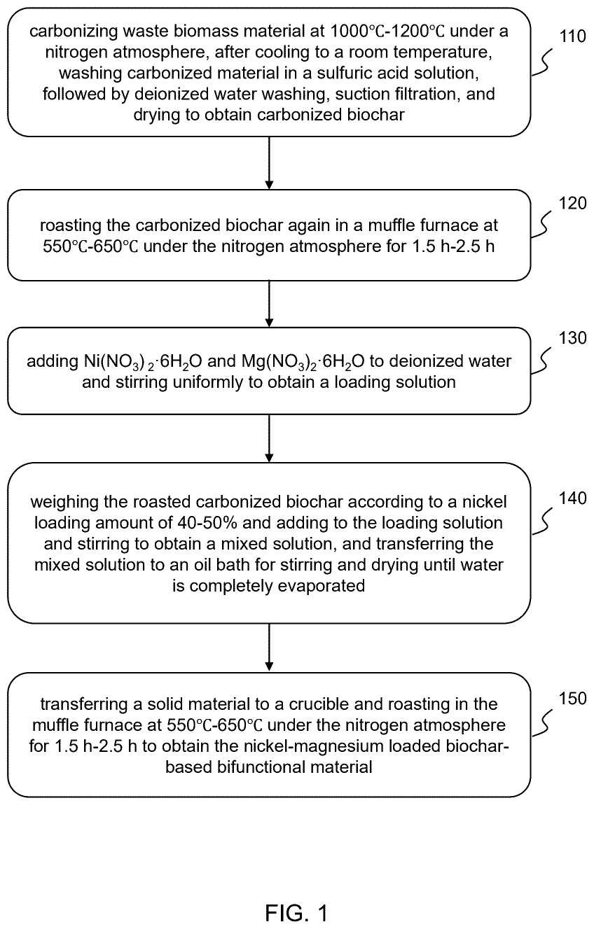

FIG. 1 is an exemplary flowchart illustrating an exemplary process of a method for preparing a nickel-magnesium loaded biochar-based bifunctional material according to some embodiments of the present disclosure.

As shown in FIG. 1, the process 100 includes the following operations.

Operation 110, carbonizing a waste biomass material at 1000° C.-1200° C. under a nitrogen atmosphere, after cooling to a room temperature, washing a carbonized material in a sulfuric acid solution, followed by deionized water washing, suction filtration, and drying to obtain a carbonized biochar.

Waste biomass material refers to organic waste that is not effectively utilized in the existing production process, with resource recovery potential, for example, agricultural straw, forestry residues, or the like.

In some embodiments, the waste biomass material is one or a mixture of a corncob powder, a yellow bamboo powder, a wheat straw powder, and a corn stover powder.

Carbonized biochar refers to a solid material produced by carbonization reaction of the waste biomass material under high temperature and oxygen-limited conditions.

The nitrogen atmosphere refers to an oxygen-free or low-oxygen environment dominated by nitrogen, which is formed and maintained in the reaction system (e.g., a muffle furnace, a tube furnace) by continuously introducing high-purity nitrogen into the reaction system during high-temperature treatment.

In some embodiments, a carbonization process of the waste biomass material may be realized by a tube furnace or a muffle furnace equipped with an intelligent temperature control system. As an example, a crucible loaded with the waste biomass material may be placed in a furnace chamber. The temperature control system is activated to set a heating program, such as increasing the temperature from a room temperature to a target temperature range (e.g., 1000° C.-1200° C., including but not limited to 1000° C., 1050° C., 1100° C., 1150° C., and 1200° C.) at a rate of 8° C./min-10° C./min. Upon reaching the target temperature range, the intelligent temperature control system maintains the temperature for 0.8 h-1.2 h to ensure complete pyrolysis and carbonization of the waste biomass material. The room temperature refers to a relatively stable temperature state achieved without the intervention of deliberate heating, cooling, or temperature regulation measures.

In some embodiments, the waste biomass material is carbonized at 1000° C.-1200° C. under the nitrogen atmosphere with a flow rate of 100 mL/min, with a heating rate of 8° C./min-10° C./min, and maintained for 0.8 h-1.2 h. After cooling to the room temperature, the carbonized material is washed in a 0.4-0.5 mol/L sulfuric acid solution for 10 h-12 h, followed by deionized water washing, suction filtration, and drying to obtain carbonized biochar.

In some embodiments of the present disclosure, the waste biomass material is carbonized at 1000° C.-1200° C. under the nitrogen atmosphere with a flow rate of 100 mL/min, with the heating rate of 8° C./min-10° C./min, and maintained for 0.8 h-1.2 h, which can effectively prevent oxidation and form a highly stable porous carbon structure. After cooling to the room temperature, the carbonized material is washed in a 0.4-0.5 mol/L sulfuric acid solution for 10 h-12 h to remove ash and impurities, thereby enhancing purity and surface activity. Subsequent deionized water washing and drying ensure product cleanliness, ultimately yielding carbonized biochar with superior adsorption capacity and chemical stability.

Operation 120, roasting the carbonized biochar again in a muffle furnace at 550° C.-650° C. under the nitrogen atmosphere for 1.5 h-2.5h.

In some embodiments of the present disclosure, the carbonized biochar may be roasted again in a muffle furnace at 550° C.-650° C. under the nitrogen atmosphere for 1.5 h-2.5 h, which can effectively stabilize the pore structure of the carbonized biochar, thereby preventing metal particle agglomeration caused by structural instability in the subsequent loading of metal salt.

Operation 130, adding Ni(NO₃)₂·6H₂O and Mg(NO₃)₂·6H₂O to deionized water and stirring uniformly to obtain a loading solution.

Loading refers to attaching and fixing nickel and magnesium precursors on the surface of the carbonized biochar. The loading solution refers to a liquid medium for loading nickel and magnesium precursors onto the surface of the carbonized biochar.

Operation 140, weighing the roasted carbonized biochar according to a nickel loading amount of 40%-50% and adding to the loading solution and stirring to obtain a mixed solution, and transferring the mixed solution to an oil bath for stirring and drying until water is completely evaporated.

The loading amount refers to a mass of nickel and magnesium precursors attached to the carbonized biochar. For example, the nickel loading amount is a mass of nickel precursors attached to the carbonized biochar.

In some embodiments, the carbonized biochar is weighed according to a nickel loading amount of 20%-50% and added to the loading solution and stirred to obtain a mixed solution, and the mixed solution is transferred to an oil bath at 90° C. for stirring and drying until water is completely evaporated to obtain a solid material.

In some embodiments, the carbonized biochar is weighed according to a nickel loading amount of 40%-50% and added to the loading solution and stirred to obtain a mixed solution, and the mixed solution is transferred to an oil bath at 90° C. for stirring and drying until water is completely evaporated to obtain a solid material.

In some embodiments, a content of magnesium in the loading solution is controlled at approximately 20 wt %.

Operation 150, transferring a solid material to a crucible and roasting in the muffle furnace at 550° C.-650° C. under the nitrogen atmosphere for 1.5 h-2.5 h to obtain the nickel-magnesium loaded biochar-based bifunctional material.

In some embodiments of the present disclosure, the raw materials and preparation cost for the nickel-magnesium loaded biochar-based bifunctional material are low, with a simple preparation process and environmental friendliness. Additionally, the material possesses rich pore structure, which significantly enhances CO₂ adsorption/conversion capacity, and substantially improves methanation performance at low temperatures. Remarkably, it exhibits excellent cycling performance, enabling efficient flue gas CO₂ capture and in-situ methanation.

The present disclosure is further explained through the following examples; and these examples are provided solely to illustrate the present disclosure and should not be construed as limiting its scope.

### Example 1

Weigh 10 g of corn stover powder into a crucible, place the crucible in a muffle furnace at 1200° C. for a first carbonization, introduce N₂ into the muffle furnace at a flow rate of 100 mL/min, set a heating rate of the muffle furnace to 10° C./min, and hold for 1 h. After cooling to room temperature, take out the carbonized black material and stir-wash it in 0.5 mol/L sulfuric acid solution for 12 h. Subsequently, wash with deionized water, perform suction filtration, and dry to obtain carbonized biochar.

Add 1.4 g of Ni(NO₃)₂·6H₂O and 2.56 g of Mg(NO₃)₂·6H₂O into the deionized water, followed by stirring for 20 min. Then weigh 1 g of the prepared carbonized biochar and add it into the above solution, followed by stirring for 30 min to obtain a mixed solution. Subsequently, transfer the mixed solution to an oil bath at 90° C. for stirring and drying until water is completely evaporated to obtain a solid material. Finally, transfer the obtained solid material to a crucible and roast in a muffle furnace at 600° C. under a nitrogen atmosphere at a N₂ flow rate of 100 mL/min for 2 h, with a heating rate of 5° C./min. After the temperature of the muffle furnace cools to the room temperature, the biochar-based bifunctional material with a nickel oxide content of 20 wt % was obtained, denoted as 20% Ni@MgO—C.

### Example 2

Weigh 10 g of yellow bamboo powder into a crucible, place the crucible in a muffle furnace at 1200° C. for a first carbonization, introduce N₂ into the muffle furnace at a flow rate of 100 mL/min, set a heating rate of the muffle furnace to 10° C./min, and hold for 1 h. After cooling to room temperature, take out the carbonized black material and stir-wash it in 0.5 mol/L sulfuric acid solution for 12 h. Subsequently, wash with deionized water, perform suction filtration, and dry to obtain first carbonized biochar.

Transfer the first carbonized biochar into a crucible and place the crucible in a muffle furnace at 600° C. for a secondary carbonization under a nitrogen atmosphere, with a heating rate of 5° C./min, and hold for 2 h to obtain carbonized biochar with strong thermal stability.

Add 2.32 g of Ni(NO₃)₂·6H₂O and 2.56 g of Mg(NO₃)₂·6H₂O into the deionized water, followed by stirring for 20 min. Then weigh 1 g of the prepared carbonized biochar and add it into the above solution, followed by stirring for 30 min to obtain a mixed solution. Subsequently, transfer the mixed solution to an oil bath at 90° C. for stirring and drying until water is completely evaporated to obtain a solid material. Finally, transfer the obtained solid material to a crucible and roast in a muffle furnace at 600° C. under the nitrogen atmosphere under a nitrogen atmosphere at a N₂ flow rate of 100 mL/min for 2 h, with a heating rate of 5° C./min. After the temperature of the muffle furnace cools to the room temperature, the biochar-based bifunctional material with a nickel oxide content of 30 wt % was obtained, denoted as 30% Ni@MgO—C.

### Example 3

Weigh 10 g of wheat straw powder into a crucible, place the crucible in a muffle furnace at 1200° C. for a first carbonization, introduce N₂ into the muffle furnace at a flow rate of 100 mL/min, set a heating rate of the muffle furnace to 10° C./min, and hold for 1 h. After cooling to room temperature, take out the carbonized black material and stir-wash it in 0.5 mol/L sulfuric acid solution for 12 h. Subsequently, wash with deionized water, perform suction filtration, and dry to obtain first carbonized biochar.

Transfer the first carbonized biochar into a crucible and place the crucible in a muffle furnace at 600° C. for a secondary carbonization under a nitrogen atmosphere, with a heating rate of 5° C./min, and hold for 2 h to obtain carbonized biochar with strong thermal stability.

Add 3.78 g of Ni(NO₃)₂·6H₂O and 3.20 g of Mg(NO₃)₂·6H₂O into the deionized water, followed by stirring for 20 min. Then weigh 1 g of the prepared carbonized biochar and add it into the above solution, followed by stirring for 30 min to obtain a mixed solution. Subsequently, transfer the mixed solution to an oil bath at 90° C. for stirring and drying until water is completely evaporated to obtain a solid material. Finally, transfer the obtained solid material to a crucible and roast in a muffle furnace at 600° C. under a nitrogen atmosphere at a N₂ flow rate of 100 mL/min for 2 h, with a heating rate of 5° C./min. After the temperature of the muffle furnace cools to the room temperature, the biochar-based bifunctional material with a nickel oxide content of 40 wt % was obtained, denoted as 40% Ni@MgO—C.

### Example 4

Weigh 10 g of corncob powder into a crucible, place the crucible in a muffle furnace at 1200° C. for a first carbonization, introduce N₂ into the muffle furnace at a flow rate of 100 mL/min, set a heating rate of the muffle furnace to 10° C./min, and hold for 1 h. After cooling to room temperature, take out the carbonized black material and stir-wash it in 0.5 mol/L sulfuric acid solution for 12 h. Subsequently, wash with deionized water, perform suction filtration, and dry to obtain first carbonized biochar.

Transfer the first carbonized biochar into a crucible and place the crucible in a muffle furnace at 600° C. for a secondary carbonization under a nitrogen atmosphere, with a heating rate of 5° C./min, and hold for 2 h to obtain carbonized biochar with strong thermal stability.

Add 6.40 g of Ni(NO₃)₂·6H₂O and 4.32 g of Mg(NO₃)₂·6H₂O into the deionized water, followed by stirring for 20 min. Then weigh 1 g of the prepared carbonized biochar and add it into the above solution, followed by stirring for 30 min to obtain a mixed solution. Subsequently, transfer the mixed solution to an oil bath at 90° C. for stirring and drying until water is completely evaporated to obtain a solid material. Finally, transfer the obtained solid material to a crucible and roast in a muffle furnace at 600° C. under the nitrogen atmosphere at a N₂ flow rate of 100 mL/min for 2 h, with a heating rate of 5° C./min. After the temperature of the muffle furnace cools to the room temperature, the biochar-based bifunctional material with a nickel oxide content of 50 wt % was obtained, denoted as 50% Ni@MgO—C.

### Comparative Example 1

Add 7.75 g of Ni(NO₃)₂·6H₂O and 19.23 g of Mg(NO₃)₂·6H₂O into the deionized water, followed by stirring for 20 min to obtain a mixed solution. Subsequently, transfer the mixed solution to an oil bath at 90° C. for stirring and drying until water is completely evaporated to obtain a solid material. Finally, transfer the obtained solid material to a crucible and roast in a muffle furnace at 600° C. under a nitrogen atmosphere at a N₂ flow rate of 100 mL/min for 2 h, with a heating rate of 5° C./min. After the temperature of the muffle furnace cools to the room temperature, the pure metal oxide dual functional material (or known as the pure metal oxide bifunctional material) with a nickel oxide content of 40 wt % was obtained, denoted as 40% Ni@MgO.

### Performance Testing and Characterization

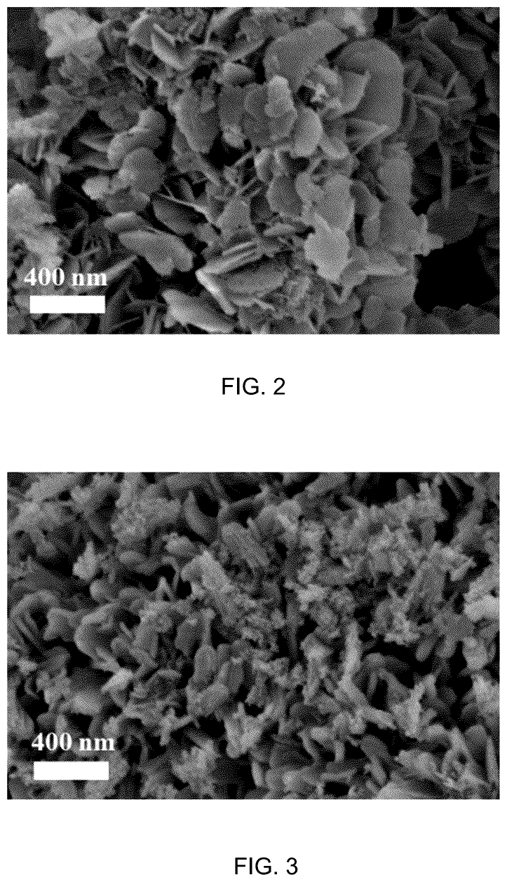

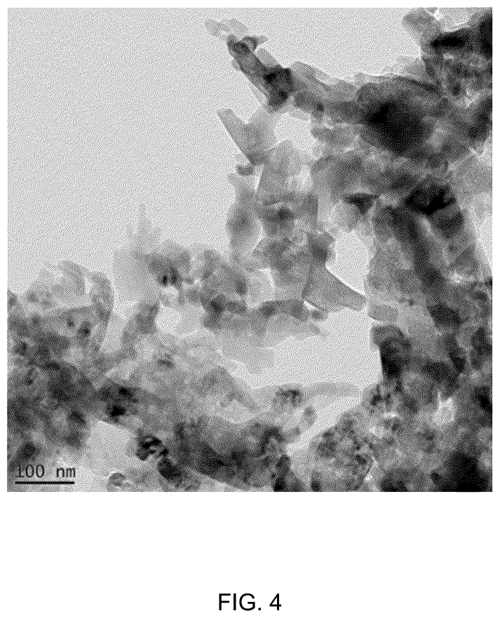

I. Scanning Electron Microscope (SEM) test results of the nickel-magnesium loaded biochar-based bifunctional materials prepared in Examples 1 and 3 are presented in FIGS. 2 and 3, and Transmission Electron Microscope (TEM) test result of the pure metal oxide dual functional material prepared in Comparative Example 1 are presented in FIG. 4.

As shown in FIGS. 2 and 3, the 20% Ni@Mg—O prepared in Example 1 primarily exhibits regular disc-shaped flakes. This morphology is nearly identical to that of layered double hydroxides (LDHs), suggesting the formation of NiMg-LDH during the one-step preparation process. The 40% Ni@MgO—C prepared in Example 3 exhibits a large number of rod-like structures, basically without regular disc-shaped flakes. This indicates that when nickel oxide becomes the main component, Ni and Mg cannot form LDH materials. As shown in FIG. 4, the 40% Ni@MgO prepared in Comparative Example 1 without carbonized biochar primarily exhibits aggregated granular morphology.

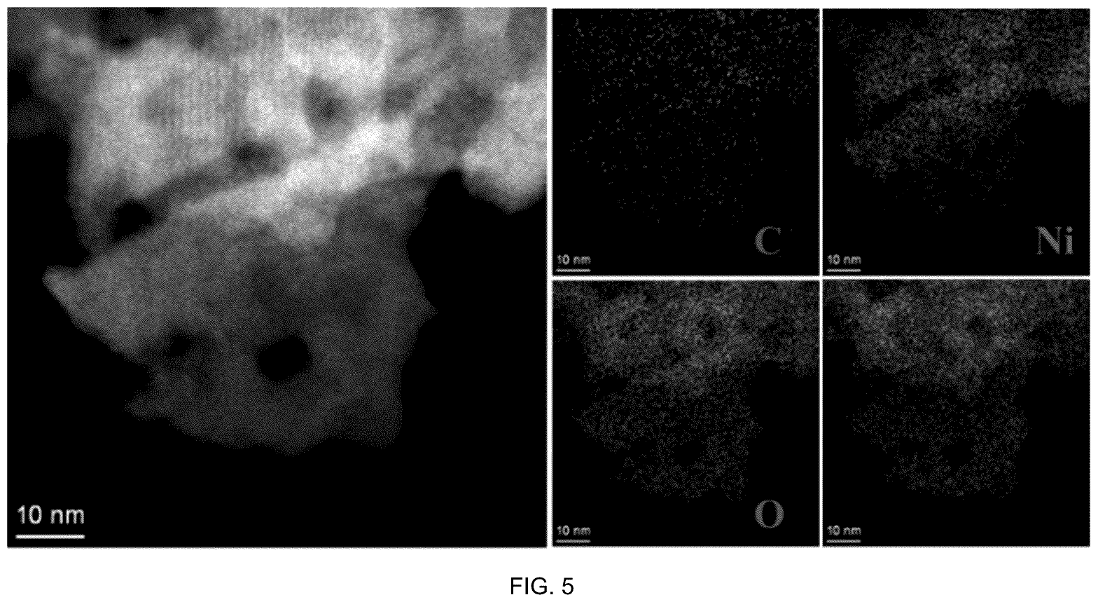

II. Energy Dispersive X-ray Spectroscopy (EDX) mapping test result of the nickel-magnesium loaded biochar-based bifunctional material prepared in Example 3 is presented in FIG. 5.

The result indicates that in the EDX elemental mapping image of the 40% Ni@MgO—C prepared in Example 3, four elements are uniformly distributed, with a carbon content significantly lower than other three elements.

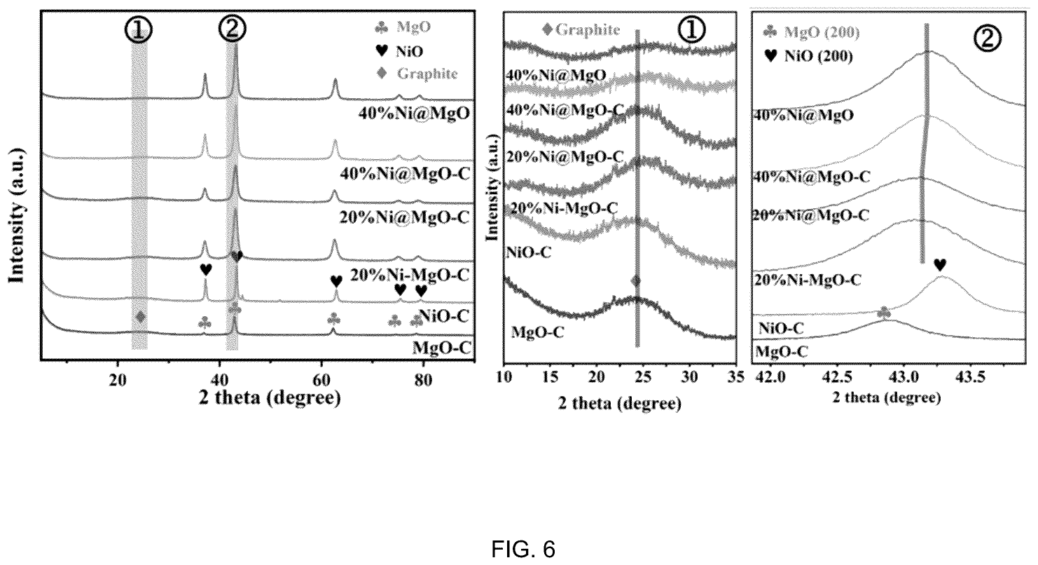

III. X-ray diffraction phase analysis (XRD) was performed on the bifunctional materials prepared in Examples 1 and 3 and Comparative Example 1 to analyze the crystal structures, and the results are presented in FIG. 6.

The results indicate that the bifunctional materials prepared in Example 1, Example 3, and Comparative Example 1 all exhibit characteristic peaks of MgO, NiO, and graphite, as shown in the total XRD spectrum. From the magnified view of the graphite (002) characteristic peak, the characteristic peak near 2θ≈25° is very gentle, indicating the predominant presence of amorphous biochar rather than true graphite. In contrast, the characteristic peaks of the two metal oxides are relatively sharp, demonstrating their high crystallinity. The (200) characteristic peaks of the bifunctional materials prepared in Examples 1 and 3 and Comparative Example 1 are located between those of MgO (200) and NiO (200), with 2θ shifting toward the characteristic peak of NiO as the nickel content increases, indicating the formation of an alloy of MgO and NiO.

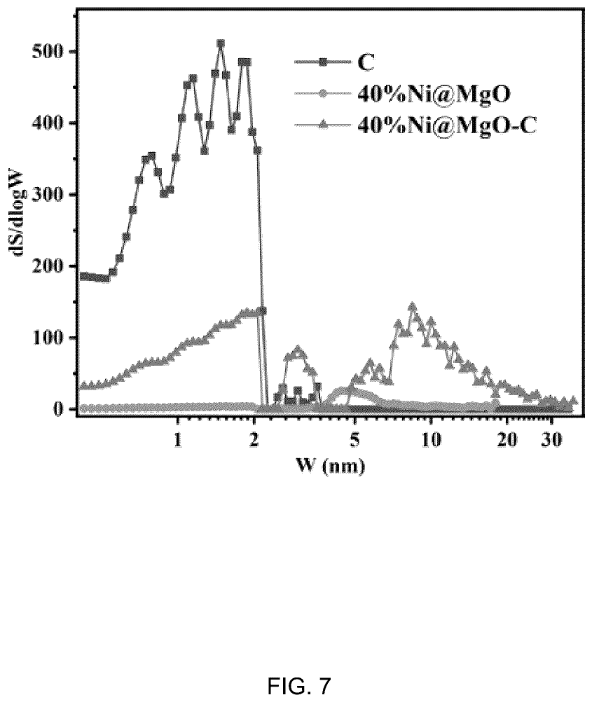

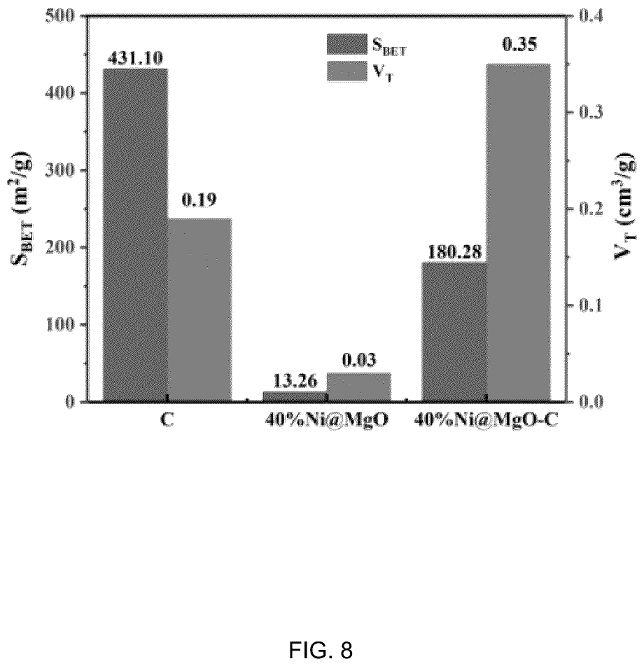

IV. The pore structures of the bifunctional materials prepared in Example 3 and Comparative Example 1 were characterized, with a pore size distribution shown in FIG. 7 and pore structure parameters shown in FIG. 8.

The results indicate that from the pore size distribution in FIG. 7, the 40% Ni@MgO—C prepared in Example 3 contains both micropores and mesopores, whereas the 40% Ni@MgO prepared in Comparative Example 1 exhibits nearly no pore structure. From the pore structure parameters in FIG. 8, the 40% Ni@MgO prepared in Comparative Example 1 has extremely low pore volume and specific surface area, whereas the 40% Ni@MgO—C prepared in Example 3 has the highest pore volume (0.35 cm3/g). Evidently, the incorporation of carbonized biochar significantly enhances the pore structure of the nickel-magnesium loaded biochar-based bifunctional material, which markedly improves both adsorption and conversion of CO₂.

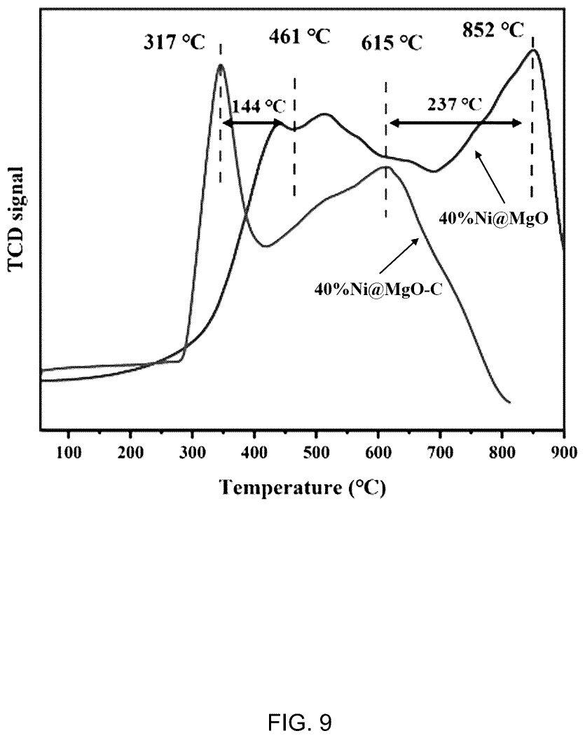

V. The H₂-temperature-programmed reduction (H₂-TPR) results of the bifunctional materials prepared in Example 3 and Comparative Example 1 are presented in FIG. 9.

The results indicate that the 40% Ni@MgO—C prepared in Example 3 exhibits two distinct reduction peaks at 317° C. and 615° C., while the 40% Ni@MgO prepared in Comparative Example 1 also shows two reduction peaks, with the temperature shifting to 461° C. and 852° C., respectively. This indicates that the incorporation of carbonized biochar significantly enhances the reducibility of the nickel-magnesium loaded biochar-based bifunctional material, suggesting that the 40% Ni@MgO—C prepared in Example 3 would exhibit superior methanation performance at low temperatures.

VI. Fixed bed adsorption penetration experiments were conducted to evaluate the CO₂ adsorption performance and methanation performance of the bifunctional materials prepared in Examples 1-4 and Comparative Example 1 under different operating conditions.

The specific testing process were as follows.

Approximately 200 mg of the bifunctional material was weighed and placed in a fixed-bed reactor, followed by raising a temperature to a target reduction temperature under pure nitrogen at a flow rate of 100 mL/min. The pure nitrogen was then switched to a mixed gas with 40% H₂ at the same flow rate for reduction of the bifunctional material. After reduction, the mixed gas was switched to pure nitrogen and purged for 20 min until a concentration of hydrogen was 0. The reactor temperature was adjusted to the target temperature for ICCM test. A mixed gas with 10% CO₂ was introduced at a flow rate of 100 mL/min for CO₂ capture for 20 min. Subsequently, the mixed gas was switched to a mixed gas with 10% H₂ at the same flow rate for 30 min of CO₂ in-site methanation. At the end of the reaction, the mixed gas was switched to pure N₂ for 20 min purge.

The CO₂ adsorption/desorption capacity, conversion rate, CO production amount, CH₄ production amount, and selectivity may be calculated using the following equations.

$${q}_{{adco}_{2}} == \frac{Q * 1000 * {\int }_{0}^{t} ( {C}_{i n} - {C}_{o u t} ) dt}{m * 44} , \qquad ( 1 )$$

$${q}_{X} = \frac{Q * 1000 * {\int }_{0}^{t} ( {C}_{X} ) d t}{m * {M}_{r}} , \qquad ( 2 )$$

$$η = \frac{{q}_{c o} + {q}_{C {H}_{4}}}{{q}_{{adco}_{2}} - {q}_{d e c {o}_{2}}} , \qquad ( 3 )$$

$${X}_{C {H}_{4}} = \frac{{q}_{C {H}_{4}}}{- {q}_{c o} + {q}_{C {H}_{4}}} * 1 \; 00 \% , \qquad ( 4 )$$

In Eq. (1), q_{adco}_{₂} (mmol/g) is the adsorption capacity of CO₂, Q is a total gas flow rate (mL/min), Cᵢₙ (mg/m³) and Cₒᵤₜ are mass concentrations of CO₂ at the inlet and outlet, respectively, and m is a mass of the bifunctional material. In Eq. (2), q_{X} (mmol/g) is the production amount, C_{X} (mg/m³) is a mass concentration, where X is one of CO, CH₄ and desorbed CO₂, and Mᵣ is a relative molecular mass of the corresponding molecule. In Eq. (3), η is a CO₂ conversion rate, and in Eq. (4), X_{CH}_{₄} is the CH₄ selectivity.

The CH₄ selectivity refers to a mole percentage of methane (CH₄) produced to all carbon-based products (CO, CH₄) in the CO₂ conversion reaction.

After reduction at 500° C., the bifunctional material was tested at 400° C., with the test data summarized in Table 1.

TABLE 1
Test results of the bifunctional materials prepared
in Examples 1-4 and Comparative Example 1 at 400° C.

| | CO₂ | CO₂ | | CO | CH₄ | |
|---|---|---|---|---|---|---|
| | adsorption | desorption | CO₂ | production | production | CH₄ |
| | capacity | capacity | conversion | amount | amount | selectivity |
| | (mmol/g) | (mmol/g) | rate (%) | (mmol/g) | (mmol/g) | (%) |
| Example 1 | 0.949 | 0.261 | 44.61 | 0.146 | 0.161 | 52.46 |
| Example 2 | 0.907 | 0.232 | 65.64 | 0.073 | 0.369 | 83.44 |
| Example 3 | 0.855 | 0.202 | 83.46 | 0.030 | 0.514 | 94.41 |
| Example 4 | 0.775 | 0.169 | 88.55 | 0.044 | 0.492 | 91.71 |
| Comparative | 0.914 | 0.202 | 29.09 | 0.080 | 0.127 | 61.38 |
| Example 1 | | | | | | |

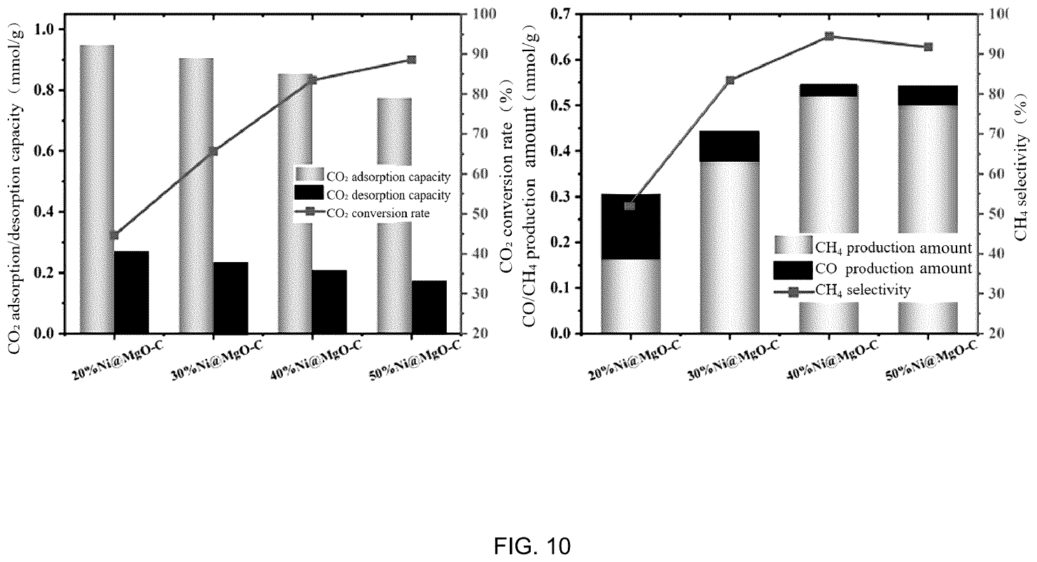

(1) The CO₂ capture and methanation performance of the nickel-magnesium loaded biochar-based bifunctional materials prepared in Examples 1-4 are shown in FIG. 10.

As shown in FIG. 10, the CO₂ adsorption/desorption capacity decreases with increasing the nickel loading amount, while the conversion rate consistently rises. Within 20%-40% of nickel loading amount, both CH₄ production amount and CH₄ selectivity increase significantly. The 40% Ni@MgO—C prepared in Example 3 has the CH₄ production amount as high as 0.51 mmol/g and selectivity up to 94.41%. However, when the nickel loading amount is 50%, the CH₄ production amount declines due to reduced CO₂ adsorption capacity. Under identical conditions, the ICCM performance of the bifunctional material prepared in Comparative Example 1 was tested and compared with those prepared in Examples 1-4, as shown in Table 1. As can be seen from Table 1, it demonstrates that only the nickel-magnesium loaded biochar-based bifunctional material prepared in Example 1 shows slightly lower performance than the bifunctional material prepared in Comparative Example 1, the nickel-magnesium loaded biochar-based bifunctional materials prepared in Examples 2-4 exhibit markedly superior performance than the bifunctional material prepared in Comparative Example 1. Overall, the four nickel-magnesium loaded biochar-based bifunctional materials prepared in Examples 1-4 exhibit certain ICCM performance, with the bifunctional material with a nickel content of 40 wt % having the best performance.

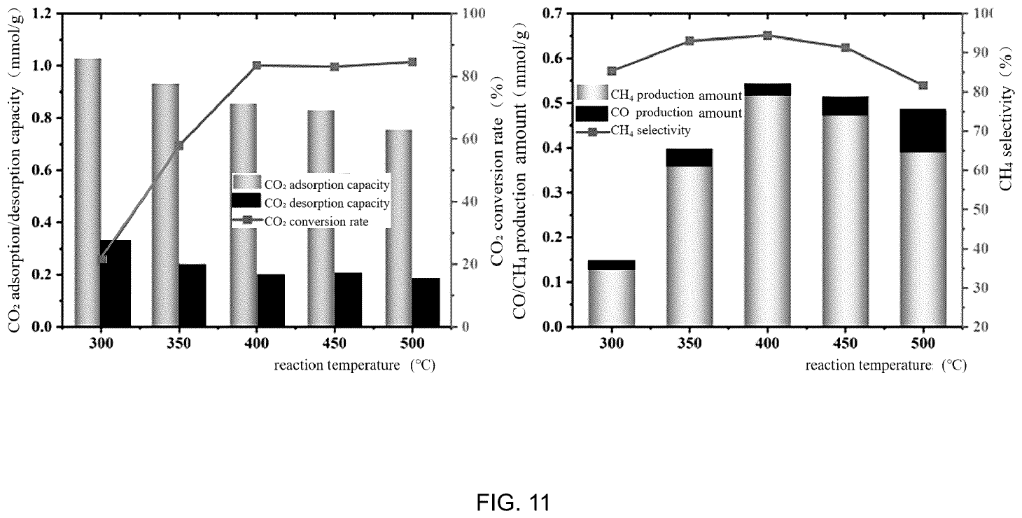

(2) The CO₂ capture and methanation performance of the 40% Ni@MgO—C prepared in Example 3 at different reaction temperatures are shown in FIG. 11.

The adsorption capacity of the 40% Ni@MgO—C is maximum of 1.03 mmol/g at 300° C. With the increase of adsorption temperature, both CO₂ adsorption and desorption capacities gradually decrease. The CO₂ conversion rate of the 40% Ni@MgO—C increases with the increase of reaction temperature, and the conversion rates at all temperatures are always higher than that of the 40% Ni@MgO prepared in the Comparative Example 1. The optimum reaction temperature for 40% Ni@MgO—C is 400° C. When the temperature is lower than 400° C., the production amounts of both CH₄ and CO are low due to low CO₂ conversion rate. When the temperature is higher than 400° C., although the CO₂ conversion rate is high, the total production amounts of both CO and CH₄ decrease due to the low CO₂ adsorption capacity, and the main factor limiting the methanation performance at this time is the CO₂ adsorption process. In summary, the nickel-magnesium loaded biochar-based bifunctional materials can exhibit certain ICCM performance at 300° C.-500° C., and 400° C. is the optimal reaction temperature.

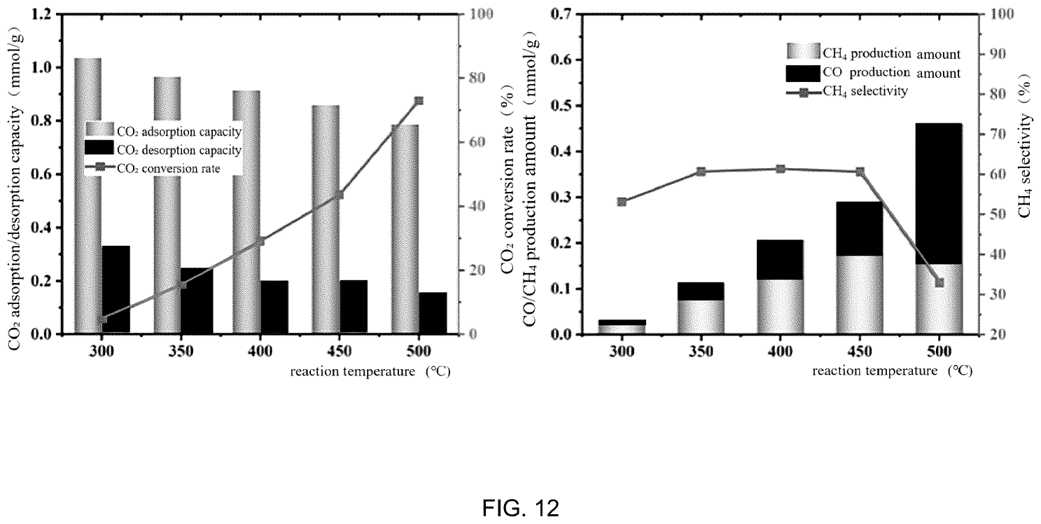

(3) The CO₂ capture and methanation performance of the 40% Ni@MgO prepared in Comparative Example 1 at different reaction temperatures are shown in FIG. 12.

As shown in FIG. 12, the CO₂ adsorption and desorption capacities of the 40% Ni@MgO also decreases with the increase of adsorption temperature and the CO₂ adsorption and desorption capacities are basically the same as that of the 40% Ni@MgO—C at each temperature. The CO₂ conversion rate of the 40% Ni@MgO prepared in Comparative Example 1 increases with increasing reaction temperature. The methane production amount of the 40% Ni@MgO at 400° C. is 0.13 mmol/g, with a methane selectivity of 61.38%, which is similar to the performance of the pure metal nickel-magnesium DFM reported to date. With the reaction temperature increasing, the total CO and CH₄ production amounts of the 40% Ni@MgO increase. The CH₄ production amount is 0.15 mmol/g when the reaction temperature increases to 500° C., whereas the CO production amount reaches 0.31 mmol/g, and the CH₄ selectivity is only 32.94%. The variation trend of the total production amount with temperature is different from that of the 40% Ni@MgO—C because the main factor limiting the production amount at this time is the catalytic performance rather than adsorption performance. As shown in FIGS. 10 and 11, the incorporation of biochar has little impact on CO₂ adsorption capacity, but significantly enhances the subsequent CO₂ in-situ methanation performance. At identical reaction temperature, the CH₄ production amount and selectivity of the 40% Ni@MgO are significantly lower than those of the 40% Ni@MgO—C, demonstrating that the incorporation of the biochar substantially enhances methanation performance. On the one hand, the incorporation of biochar enhances the catalytic activity of the DFM, dramatically increasing the CO₂ conversion rate at a relatively low temperature; on the other hand, the incorporation of the biochar suppresses the inverse water-gas shift reaction, dramatically improving the CH₄ selectivity.

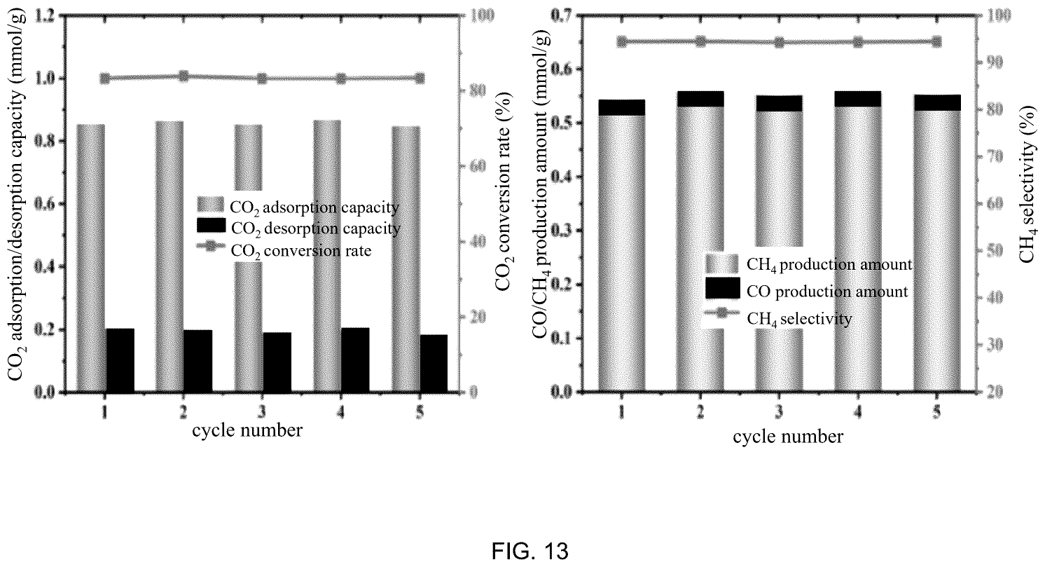

(4) The cycling performance of the 40% Ni@MgO—C prepared in Example 3 is shown in FIG. 13.

It can be seen from five cycle tests that the 40% Ni@MgO—C maintains stable CO₂ adsorption/desorption capacity and conversion rate without significant decrease, the CH₄ production amount basically remains between 0.51-0.53 mmol/g and the CH₄ selectivity also remains around 94%, exhibiting exceptional cycling performance.

In some embodiments, the aforementioned nickel-magnesium loaded biochar-based bifunctional material may be used in integrated flue gas carbon capture and in-situ methanation.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure and are within the spirit and scope of the exemplary embodiments of this disclosure.

Moreover, certain terminology has been used to describe embodiments of the present disclosure. For example, the terms “one embodiment,” “an embodiment,” and “some embodiments” mean that a particular feature, structure, or feature described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures, or features may be combined as suitable in one or more embodiments of the present disclosure.

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose and that the appended claims are not limited to the disclosed embodiments, but, on the contrary, are intended to cover modifications and equivalent arrangements that are within the spirit and scope of the disclosed embodiments. For example, although the implementation of various parts described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

In some embodiments, numbers describing the number of ingredients and attributes are used. It should be understood that such numbers used for the description of the embodiments use the modifier “about”, “approximately”, or “substantially” in some examples. Unless otherwise stated, “about”, “approximately”, or “substantially” indicates that the number is allowed to vary by ±20%. Correspondingly, in some embodiments, the numerical parameters used in the description and claims are approximate values, and the approximate values may be changed according to the required features of individual embodiments. In some embodiments, the numerical parameters should consider the prescribed effective digits and adopt the method of general digit retention. Although the numerical ranges and parameters used to confirm the breadth of the range in some embodiments of the present disclosure are approximate values, in specific embodiments, settings of such numerical values are as accurate as possible within a feasible range.

For each patent, patent application, patent application publication, or other materials cited in the present disclosure, such as articles, books, specifications, publications, documents, or the like, the entire contents of which are hereby incorporated into the present disclosure as a reference. The application history documents that are inconsistent or conflict with the content of the present disclosure are excluded, and the documents that restrict the broadest scope of the claims of the present disclosure (currently or later attached to the present disclosure) are also excluded. It should be noted that if there is any inconsistency or conflict between the description, definition, and/or use of terms in the auxiliary materials of the present disclosure and the content of the present disclosure, the description, definition, and/or use of terms in the present disclosure is subject to the present disclosure.

Finally, it should be understood that the embodiments described in the present disclosure are only used to illustrate the principles of the embodiments of the present disclosure. Other variations may also fall within the scope of the present disclosure. Therefore, as an example and not a limitation, alternative configurations of the embodiments of the present disclosure may be regarded as consistent with the teaching of the present disclosure. Accordingly, the embodiments of the present disclosure are not limited to the embodiments introduced and described in the present disclosure explicitly.

What is claimed is:

1. A method for preparing a nickel-magnesium loaded biochar-based bifunctional material, the method comprising:
carbonizing a waste biomass material at 1000° C.-1200° C. under a nitrogen atmosphere, after cooling to a room temperature, washing a carbonized material in a sulfuric acid solution, followed by deionized water washing, suction filtration, and drying to obtain a carbonized biochar;
roasting the carbonized biochar again in a muffle furnace at 550° C.-650° C. under the nitrogen atmosphere for 1.5 h-2.5 h;
adding Ni(NO₃)₂·6H₂O and Mg(NO₃)₂·6H₂O to deionized water and stirring uniformly to obtain a loading solution;
weighing the roasted carbonized biochar according to a nickel loading amount of 40%-50% and adding to the loading solution and stirring to obtain a mixed solution, and transferring the mixed solution to an oil bath for stirring and drying until water is completely evaporated; and
transferring a solid material to a crucible and roasting in the muffle furnace at 550° C.-650° C. under the nitrogen atmosphere for 1.5 h-2.5 h to obtain the nickel-magnesium loaded biochar-based bifunctional material.

2. The method for preparing the nickel-magnesium loaded biochar-based bifunctional material according to claim 1, wherein a concentration of the sulfuric acid solution is within a range of 0.4-0.5 mol/L, and a time of the washing is within a range of 10 h-12 h.

3. The method for preparing the nickel-magnesium loaded biochar-based bifunctional material according to claim 1, wherein during the preparation of the carbonized biochar, the nitrogen atmosphere is maintained at a flow rate of 100 mL/min, a heating rate is within a range of 8° C./min-10° C./min, and a holding time is within a range of 0.8 h-1.2 h.

4. The method for preparing the nickel-magnesium loaded biochar-based bifunctional material according to claim 1, wherein during the roasting of the solid material, the nitrogen atmosphere is maintained at a flow rate of 100 mL/min, and a heating rate is within a range of 4° C./min-5° C./min.

5. The method for preparing the nickel-magnesium loaded biochar-based bifunctional material according to claim 1, wherein the waste biomass material is one or a mixture of a corncob powder, a yellow bamboo powder, a wheat straw powder, and a corn stover powder.

6. A nickel-magnesium loaded biochar-based bifunctional material, which is prepared by the method according to claim 1.
